(19) United States
(12) Patent Application Publication
(10) Pub. No.: US 2012/0187793 A1
(43) Pub. Date: Jul. 26, 2012

(54) ROTOR

(75) Inventors: Ulrich Hartmann, Berlin (DE); Oliver Memminger, Neuburg A.D. Inn (DE); Joachim Mucha, Berlin (DE); Matthias Tutsch, Furstenzell (DE)

(73) Assignee: Siemens Aktiengesellschaft, Munchen (DE)

(21) Appl. No.: 13/498,797

(22) PCT Filed: Sep. 27, 2010
(86) PCT No.: PCT/EP2010/064270

§ 371 Date: Mar. 28, 2012

(30) Foreign Application Priority Data
Sep. 29, 2009 (DE) 10 2009 043 419.4

(51) Int. Cl. H02K 1/28; H02K 15/03

(52) U.S. Cl. 310/156.28; 29/598

(57) ABSTRACT

The invention relates to a rotor (1) of a rotating dynamoelectric machine, comprising permanent magnets (3) which are arranged on the circumference of the rotor base (4), said permanent magnets (3) being positioned and secured by at least one collar (2) which is closed in circumferential direction.

The invention relates to a rotor body with permanent magnets in a rotary dynamo-electric machine.

In particular in the case of large dynamo-electric machines (motors or generators), for example for gearless turbines in wind or tidal power-stations, the permanent magnets for permanently excited synchronous machines are attached to the rotor body using high-outlay manufacturing technology.

Thus EP 1 860 755 A2 describes one possibility, whereby a basic body carries a magnet which, in turn, is held on the basic body by a cover shroud and bolts, whereby the basic body itself is attached to a mount.

DE 195 03 511 A1 discloses a synchronous linear motor with a primary component which is provided with a winding and a secondary component which consists of a bearing plate which extends in the longitudinal direction and onto which are permanently bonded, while maintaining the pole center spacing dimension, ready-magnetized permanent magnets which consist of a material which is brittle and susceptible to corrosion. In order to be able to permanently bond the ready-magnetized permanent magnets onto the secondary component with low manufacturing outlay and with high precision, it is there proposed that spacing elements, corresponding to the pole center spacing dimension of the synchronous linear motor, are arranged between the ready-magnetized permanent magnets. These are then protected additionally by a cover plate.

With all of these ways of fixing permanent magnets onto a rotor body, the outlay for the manufacturing technology is comparatively high.

Starting from this point, the underlying objective is to devise a rotor body, in particular for permanently-excited synchronous machines with a nominal power greater than 1 MW, on which the permanent magnets can be positioned and fixed with comparatively low outlay.

The solution to the objective posed is achieved by a rotor in a rotary dynamo-electric machine, with permanent magnets which are arranged on the circumference of a rotor body, where the permanent magnets are positioned and fixed by at least one sleeve which is closed in the circumferential direction.

The solution to the objective posed is also achieved by the following steps in a method for the manufacture of a rotor:
provision of a rotor body,
placing the sleeve or sleeve components on the circumference of the rotor body so as to form pockets running axially,
insert the permanent magnets axially into the axially-oriented pockets, so that poles are formed on the rotor body,
encapsulate the permanent magnets in the pockets.

The sleeve is a component which is comparatively easy to manufacture from shaped sheet, which is preferably made from a metal or GRP. As a fully edge-finished sleeve, it is placed around the rotor body, to which it is attached by spot welds, rivets or bolts. These fixing arrangements will preferably be used in the sections of the sleeve which lie directly against the rotor body, that is in the inter-pole gaps.

Advantageously, this arrangement produces pockets which run axially, into which the permanent magnets can be inserted axially and then encapsulated. By this means, poles are formed on the rotor body in a simple way.

Thus, each pocket forms a pole, each of which is formed by an individual magnet.

In a further form of embodiment, each pole is formed by several individual magnets, which are arranged within a pocket and axially behind each other and/or beside each other. This simplifies assembly, because the magnetic forces which must be overcome are smaller. In addition, the stocking of parts for the permanent magnets is optimized because it is then possible, using a plurality of identical permanent magnets, which are advantageously engineered as rectilinear solids, to realize different diameters, different axial lengths of rotor body and various pole center spacings on the rotor body.

The sleeve forms a closed component around the circumference of the rotor body, so that the rotor body will if necessary have one or more sleeves of this type viewed axially along its length.

Ideally, the sleeve will be a part of an endless material with steps, on a roll with a specifiable width. Depending on the circumference of the rotor body, the material will now be taken from the roll and, for example, fixed to the rotor body by the fixing arrangement through an overlap of the sleeve ends in the inter-pole gap.

The thickness of the endless material in the radial direction will be such as to ensure that it will bend during assembly and it will also provide adequate retention of the permanent magnets during the operation of the dynamo-electric machine. The inventive sleeve will thus make it easily possible both to shape pockets, for both external and internal rotors, and to hold the permanent magnets.

In an alternative form of embodiment, the sleeve can be subdivided into individual segments running in the circumferential direction so that, for example, sleeve components which form two or more pockets can be attached to the rotor body, in particular, through overlaps in the region of the inter-pole gaps.

The invention, together with further advantageous embodiments of the invention, are explained in more detail in the drawings showing the principles. These show:

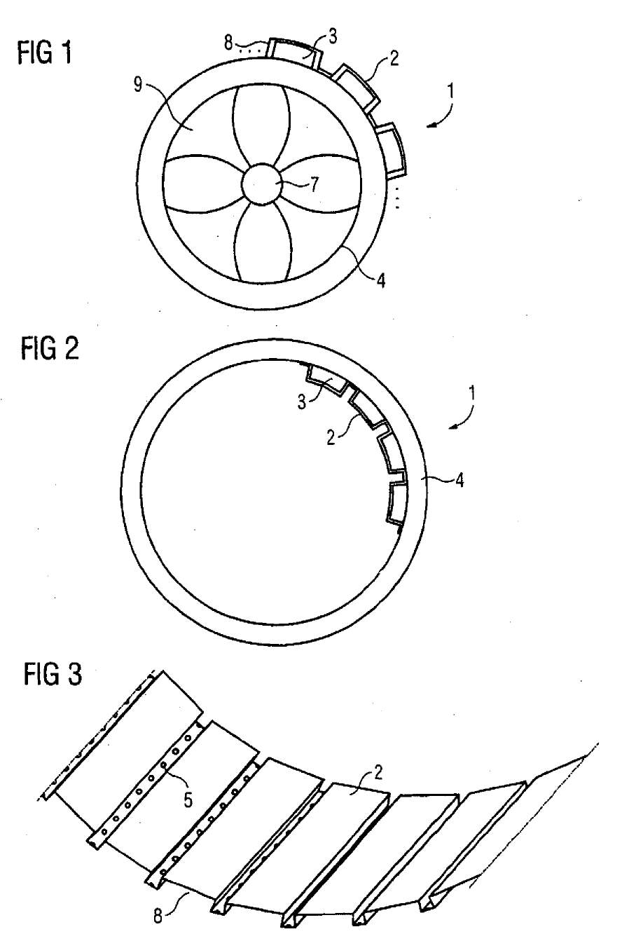

FIG. 1 a rotor in the case of an internal rotor,

FIG. 2 a rotor in the case of an external rotor,

FIG. 3 a perspective view of a partial section of a sleeve,

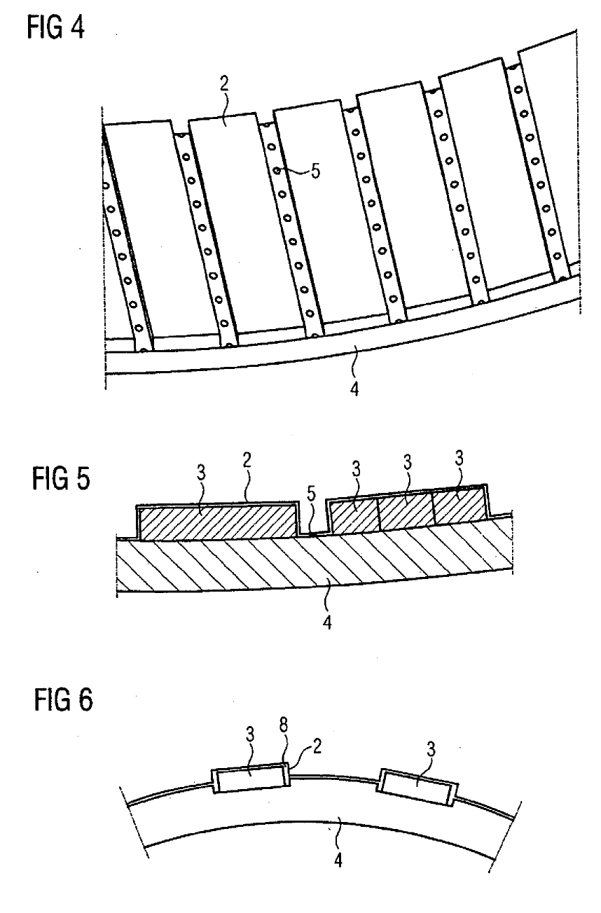

FIG. 4 a perspective view of a sleeve for an external rotor,

FIG. 5 a partial cross-section of an external rotor,

FIG. 6 a partial cross-section of an internal rotor.

A rotor 1 of a permanently-excited synchronous machine for wind power generators or wave power stations with a nominal power, in particular, greater than 1 MW, is in the form of a rotor body 4 which is laminated in the axial direction or is solid. Arranged on the surface of the rotor body 4 is a sleeve 2 which, looking in the circumferential direction, is closed, and which together with the surface of the rotor body 4 forms pockets 8, viewed in the axial direction, in which are located the permanent magnets 3.

In this situation, it is possible for several permanent magnets 3 to be arranged one behind another and/or even alongside one another in each axially oriented pocket 8. This has advantages, in particular, for the stockholding of the permanent magnets 3 because it is thereby possible to produce different pole widths on the rotor body 4 with the available permanent magnets 3.

In the case of an internal rotor as shown in FIG. 1, the rotor body 1 is shrunk onto a shaft 7, or joined to it in some other torsion-resistant way.

Particularly in the case of wind power plants, the electrical operating equipment arranged in the gondola should have as low a mass as possible, so that it is advantageous if the rotor 1 is joined, as shown schematically in FIG. 1, to the shaft 7 by an arrangement of spokes 9. The rotor body 4 then has only the radial thickness which is magnetically necessary. A rotor body 4 in this form is joined mechanically to the spoke arrangement 9.

FIG. 2 shows a rotor 1 for an external rotor in a permanently excited dynamo-electric synchronous machine, in which the sleeve 2 is arranged on the inner side of the rotor body 4, and there again it forms axially oriented pockets 8 into which are inserted permanent magnets 3.

In the case of an external rotor, the previously familiar way of fixing the permanent magnets by taping them is not possible, due to the constructional characteristics of an external rotor.

FIG. 3 shows a perspective view of a partial section of a sleeve 2 with its steps and the arrangements for fixing the sleeve 2 onto the rotor body 4. In FIG. 3 this is, by way of example, realized by means of prepunched holed in the inter-pole gaps on the sleeve 2, which can be bolted or riveted to the rotor body 4 in these gaps.

Depending on the forces imposed on the sleeve 2 when the dynamo-electrical machine is in operation, several axially distributed fixing arrangements should be provided per inter-pole gap. FIG. 4 shows, in another perspective diagram, the principle of the arrangement of the sleeve 2 on the rotor body 4 of an external rotor motor. Here, for example, the sleeve 2 forms an axially mating fit on the rotor body 4.

FIG. 5 shows a section of a partial cross-section through an external rotor on which the permanent magnets 3 are ultimately positioned on the rotor body 4 by attachment points 5 which, in the form of rivets or bolts, hold the sleeve 2 onto the rotor body 4. Into the axially oriented pockets 8, which are formed by the sleeve 2 and the rotor body 4, are inserted the permanent magnets 3 which, as shown in principle, can consist of several individual magnets per pocket 8, these being arranged alongside each other and/or axially behind one another and/or above one another.

In a preferred form of embodiment, the pockets are formed by the cylindrically shaped surface of the rotor body 4 and the stepping in the sleeve 2. In this case, the stepping is formed in such a way that the pockets 8 have cross-sections which, taking into consideration the curvature of the surface of the rotor body 4, are essentially rectangular in shape.

In a form of embodiment shown in FIG. 6, the surface of the rotor body 4 has already been provided with axial channels which, together with the stepping in the sleeve 2, form pockets 8.

In an advantageous way, the permanent magnets 3 are in addition fixed in their pockets 8 by a casting compound 6.

What is claimed is:

1.-6. (canceled)

7. A rotor for an internal or external rotor in a permanently-excited synchronous machine with a power greater than 1 MW, said rotor comprising:
a rotor body;
permanent magnets arranged on an outside or inside circumference of the rotor body;
sleeves positioning and fixing the permanent magnets on the rotor body, each said sleeve being configured in one of two ways, a first way in which the sleeve is closed in a circumferential direction, a second way in which the sleeve, when viewed in a circumferential direction, has individual segments, wherein at least one permanent magnet is provided for each pole; and
axially distributed fixing members fixing the sleeves onto the rotor body in an inter-pole gap between two poles.

8. The rotor of claim 7, wherein the rotor body and the sleeve form axial pockets for receiving the permanent magnets.

9. The rotor of claim 8, wherein each of the pockets is configured to receive several permanent magnets arranged behind each other and/or beside each other.

10. The rotor of claim 8, wherein the rotor body has a cylindrically shaped surface, said pockets being formed by the surface of the rotor body and a stepping of the sleeve.

11. The rotor of claim 8, wherein the rotor body has a surface having axial channels, said pockets being formed by the surface of the rotor body and a stepping of the sleeve.

12. The rotor of claim 7, wherein the rotor body is formed of axially laminated sheets.

13. The rotor of claim 7, wherein the rotor body is solid.

14. The rotor of claim 7, wherein the sleeve is made of metal.

15. The rotor of claim 7, wherein the sleeve is made of GRP.

16. The rotor of claim 7, for use as an external or internal rotor in a permanently excited synchronous generator for wind power plants or tidal power stations.

17. A method for manufacturing a rotor, comprising:
placing a sleeve or sleeve components on a circumference of a rotor body to form axial pockets;
axially inserting permanent magnets into the axial pockets to thereby form magnetic poles on the rotor body; and
encapsulating the permanent magnets in the pockets to thereby provide additional fixing.
